(19) United States
(12) Patent Application Publication
(10) Pub. No.: US 2025/0342360 A1
(43) Pub. Date: Nov. 6, 2025

(54) METHOD AND SYSTEM FOR PERFORMING END-TO-END EVALUATION OF A LARGE LANGUAGE MODEL (LLM)

(71) Applicant: LTI Mindtree Ltd, Mumbai (IN)

(72) Inventors: Ashish Varerkar, Mumbai (IN); Vishwanathan Raman, Chennai (IN); Anindita Desarkar, Kolkata (IN); Sateesh Gottumukkala, Bengaluru (IN); Ruchita Motwani, Ulhasnagar (IN); Raj Shah, Thane (IN)

(21) Appl. No.: 18/793,006

(22) Filed: Aug. 2, 2024

(30) Foreign Application Priority Data
May 5, 2024 (IN) 202421035511

(51) Int. Cl. G06N 3/088; G06N 3/0475

(52) U.S. Cl. CPC G06N 3/088; G06N 3/0475

(57) ABSTRACT

A method and a Large Language Model (LLM) evaluation system provides an end-to-end evaluation of LLM, which includes evaluating both input prompts and output prompt responses, wherein the evaluation includes assessing a plurality of input and output characteristics that encompasses both quality and quantity. Each of the plurality of input characteristics are assigned with a corresponding normalized score by employing one or more statistical techniques to derive a composite health score for the input prompts. Evaluation further comprises evaluating output prompt responses in both absence and presence of the ground truth. Upon evaluating both input prompts and output prompt responses, a final aggregated health score for the LLM is computed by a scorer module employing threshold based statistical techniques that considers input prompt health and output prompt response health, wherein the aggregated health score is generated based on the granular scores of each characteristic.

### FIELD

The present disclosure generally relates to Large Language Models (LLMs). More particularly, the disclosure relates to a method and system for performing end-to-end evaluation of a LLM using a set of qualitative and quantitative metrices, which evaluates both input characteristics and output characteristics to generate a health score for the LLM.

### BACKGROUND

Evaluating LLM presents a myriad of challenges due to the complex nature of natural understanding and generation. One key challenge lies in defining comprehensive evaluation criteria that encompasses the diverse dimensions of the LLM performance. One significant challenge in LLM evaluation is the sheer breadth of criteria against which the model must be assessed. Unlike available systems or processes, LLMs operate within the intricate domain of natural language understanding and generation, which encompasses various linguistic, semantic and contextual nuances.

In addition, evaluation of the LLM presents numerous challenges due to the multifaceted nature of the assessment process. The complexity arises from the need to consider multiple dimensions or aspects of the LLM's performance, each of which contributes to the overall understanding of its capabilities and limitations. A few such dimensions, for instance, can be language fluency, semantic coherence, contextual understanding, diversity and creativity, ethical considerations, performance robustness, and computational efficiency. These dimensions collectively inform the generation of a comprehensive health score for the LLM.

Each of these dimensions represents a distinct aspect of the LLM's performance, and evaluating them requires specialized metrics, methodologies, and expertise. Moreover, these dimensions are often interconnected, with improvements or deficiencies in one dimension influencing others. Therefore, achieving a comprehensive understanding of the LLM's health necessitates a holistic evaluation approach that considers the interplay between these dimensions.

Evaluation of the LLM, though it varies from user to user based on their requirement, common criteria that stakeholders often prioritize when assessing the LLM output are Biasness, Output data quality, Toxicity, Hallucination, Ethical concern, Data privacy, and Interpretability. Each of these evaluation criteria plays a major role in assessing the overall performance, reliability, and societal impact of the LLM.

Though there exist numerous solutions regarding LLM performance evaluation, evaluation remains a complex field, and a universally accepted holistic framework has yet to emerge. While there are numerous individual evaluation metrics and methodologies available, integrating them into a cohesive and comprehensive framework presents significant challenges.

For example, one such existing evaluation technique is OpenAI Evaluation, which provides a framework for evaluating LLM or systems built using LLMs. Wherein metrices that are used for evaluating the LLM are very limited, and the framework is not holistic. Also, the same set of metrices are applied for all kinds of tasks.

Despite significant efforts by researchers and practitioners, no single solution has emerged that can comprehensively evaluate the LLM using wide range of metrices that encompass both quantitative and qualitative aspects. This challenge arises from the complexity of LLMs and the diverse dimensions of their performance. Integrating these diverse metrics into a cohesive evaluation framework that provides a holistic assessment of the LLM remains an ongoing area of focus.

Evaluating the LLM requires analyzing how well they understand and respond to different types of input data, ranging from simple questions to complex prompts. Additionally, assessing the quality, relevance, and coherence of the generated output is crucial for determining the overall effectiveness of the LLM. A comprehensive evaluation solution must therefore consider both input and output characteristics, leveraging a combination of qualitative and quantitative metrics to provide nuanced understanding of the LLM performance across diverse use cases and scenarios.

There is therefore a need for a method and system that can perform an end-to-end evaluation of LLMs using wide range of metrices that assess both input and output characteristics to generate an overall health score of the LLMs.

### SUMMARY

The present disclosure proposes a method and system for performing end-to-end evaluation of LLM, which includes evaluating both input prompts and output prompt responses. The method and system evaluates input prompts by assessing input characteristics that encompasses both quality and quantity, wherein the input characteristics comprise safety, toxicity, data quality, security, presence of prompt injections, and biases. Evaluating the LLM further includes evaluating output prompt responses which assesses output characteristics that encompass both quality and quantity, wherein the output characteristics comprise honesty, helpfulness, and harmlessness. The output prompt responses are evaluated in both absence and presence of the ground truth. characteristics are assigned with a corresponding normalized score by employing one or more statistical techniques to derive a composite health score for the input prompts.

Evaluating the output prompt response in absence of ground truth further comprises, assessing answer relevance to a question, calculating hallucination probability based on answer similarity within the same LLM, calculating hallucination probability based on answer similarity across multiple LLMs, evaluating model consistency based on question-and-answer similarity, and determining hallucination probability based on reverse prompting by calculating Rouge score and BLEU score between an actual prompt and a generated reverse prompt. Evaluating the output prompt response in presence of ground truth further comprises, performing model-specific evaluation for fine-tuned models, retrieval-augmented generation (RAG) based models, and foundation models.

Upon evaluating both input prompts and output prompt responses, a final composite health score for the LLM is computed by employing threshold based statistical techniques that consider input prompt health and output prompt response health. Computing the final composite health score comprises computing an individual score for each characteristic and generating an aggregated health score based on the granular scores of each characteristic.

One or more advantages of the prior art are overcome, and additional advantages are provided through the disclosure. Additional features are realized through the technique of the disclosure. Other embodiments and aspects of the disclosure are described in detail herein and are considered a part of the disclosure.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the disclosure.

FIG. 1 is a diagram that illustrates an exemplary environment within which various embodiments of the present disclosure may function.

FIG. 2 is a diagram that illustrates the LLM evaluation system for evaluating the input characteristics and output characteristics of the LLM, in accordance with an embodiment of the disclosure.

FIG. 3 is a diagram that illustrates a flow chart for a method for performing evaluation of LLM, in accordance with an embodiment of the disclosure.

FIG. 4 is a diagram that illustrates a flow chart for a method for calculating hallucination probability based on answer similarity within the same LLM₁ in accordance with an embodiment of the disclosure.

FIG. 5 is a diagram that illustrates a flow chart for a method for calculating hallucination probability based on answer similarity across multiple LLMs (1. . . . N) in accordance with an embodiment of the disclosure.

FIG. 6 is a diagram that illustrates a flow chart for a method for evaluating LLM consistency based on question-and-answer similarity in accordance with an embodiment of the disclosure.

FIG. 7 is a diagram that illustrates a flow chart for a method for determining hallucination probability based on reverse prompting in accordance with an embodiment of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

Before describing in detail embodiments that are in accordance with the present disclosure, it should be observed that the embodiments reside primarily in combinations of components related to performing end-to-end evaluation of LLMs using metrices that are both qualitative and quantitative in nature. Accordingly, the method and system have been represented where appropriate by conventional symbols in drawing, showing only those specific details that are pertinent to understanding the embodiments of the present disclosure so as not to obscure the disclosure with details that will be readily apparent to those of ordinary skill in the art having the benefit of description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the disclosure disclose a method and system for performing end-to-end evaluation of LLMs, which includes assessing both input prompts and output prompt responses. The method and system evaluates a plurality of input prompts by assessing input characteristics that encompasses both quality and quantity. Evaluating the LLM further includes evaluating a plurality of output prompt responses which assess output characteristics that encompass both quality and quantity, wherein the output prompt responses are evaluated in both absence and presence of the ground truth.

The method and system employs one or more statistical techniques to score each of the plurality of input prompts and the output prompt responses. Statistical techniques offer a systematic and quantitative approach to analyzing the characteristics and qualities of input prompts and corresponding output responses generated by the LLM.

In some non-limiting embodiments, one commonly used statistical technique is the calculation of similarity scores between input prompts and reference data. This involves measuring the degree of similarity or overlap between the input prompt and known reference texts. Techniques such as cosine similarity, Jaccard similarity, or edit distance metrics can be employed to quantify the resemblance between textual inputs, providing insights into the LLM's ability to understand and contextualize diverse input prompts.

Similarly, statistical techniques can be used to score the quality and relevance of output responses generated by the LLM. Metrics such as BLEU (Bilingual Evaluation Understudy), ROUGE (Recall-Oriented Understudy for Gisting Evaluation), or perplexity scores can provide quantitative assessments of the fidelity and linguistic quality of the LLM's output.

The presence of ground truth in the output prompt response indicates that a known, correct answer of reference response to the given input prompt. This reference serves as a benchmark against which the output generated by the LLM can be compared.

The absence of ground truth in the output prompt response indicates that there is no definitive correct answer or reference response available for the given input prompt.

A final health score for the LLM is computed by employing threshold statistical techniques that take into account both the health scores of input prompts and the output prompt responses. Individual scores are computed for each characteristic of the LLM performance. Each characteristic is assessed using appropriate quantitative and qualitative metrics tailored to capture specific requirements.

Threshold statistical techniques, upon computation of individual scores, are applied to aggregate these scores and derive an overall health score for the LLM. These techniques involve setting thresholds that determine whether a given characteristic meets a predefined standard or acceptability.

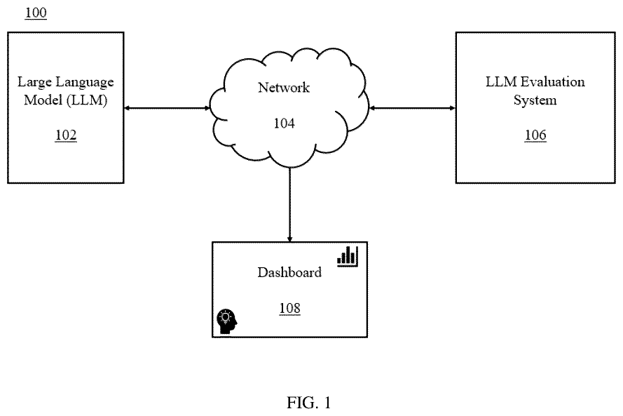

FIG. 1 is a diagram that illustrates an exemplary environment 100 within which the method and system for evaluating LLM using qualitative and quantitative metrices may function, in accordance with an embodiment of the disclosure. Referring to FIG. 1, the environment 100 comprises a Large Language Model (LLM) 102, a network 104, an LLM evaluation system 106, and a dashboard 108.

The LLM evaluation system 106 is a framework which is configured to evaluate the LLM 102 holistically by assessing input characteristics and output characteristics that encompass both quality and quantity. The LLM evaluation system 106 comprises capabilities to address the multifaceted challenges inherent in evaluating complexities in the LLM 102 by employing a holistic framework that considers a wide range of dimensions. From evaluating input prompts to evaluating output prompt responses, the LLM evaluation system 106 leverages multitude of techniques to ensure a thorough evaluation process to capture intricacies of language understanding and generation.

The network 104 includes communication networks operable to facilitate communication, either wirelessly or wired. Any of the communications networks may include, but are not limited to, any one of a combination of different types of suitable communications networks such as, for example, broadcasting networks, cable networks, public networks (for example, the Internet), private networks, wireless networks, cellular networks, or any other suitable private and/or public networks. Further, any of the communication networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Generally, the LLM evaluation system 106 is operable to communicate with the network 104 and may include logic encoded in software, hardware, or a combination of software and hardware. More specifically, the LLM evaluation system 106 may include software supporting one or more communication protocols associated with communication such that the network 104 is operable to communicate physical signals within and outside the LLM evaluation system 106.

The LLM evaluation system 106 is also operable to communicate with the dashboard 108 via the network 104. The dashboard 108 may include logic encoded in software, hardware, or a combination of software and hardware. The dashboard 108 consolidates all the characteristics that are assessed and their corresponding scores. For each characteristic, the dashboard 108 displays its respective score, derived from a combination of quantitative metrics, qualitative measurements, and statistical techniques employed during the evaluation process.

Based on the overall composite score of the LLM, the dashboard 108 offers stakeholders with easy access to key insights and metrics, facilitating informed decision-making and driving continuous improvement in LLM performance. For instance, various insights and visualizations may include trend analysis, comparative analysis, performance breakdown, correlation analysis, recommendation and actionable insights, risk assessment, and decision support tools.

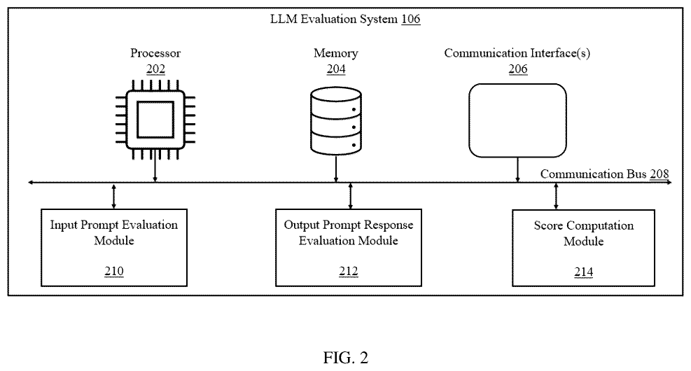

FIG. 2 is a diagram that illustrates the LLM evaluation system 106 for evaluating the input characteristics and output characteristics of a LLM, in accordance with an embodiment of the disclosure. Referring to FIG. 2, the LLM evaluation system 106 comprises a processor 202, a memory 204, one or more communication interfaces 206, a communication bus 208, an input prompt evaluation module 210, an output prompt response evaluation module 212, and a scorer module 214.

The processor 202 may comprise suitable logic, interfaces, and/or code that may be configured to execute the instructions stored in the memory 204 to implement various functionalities of the LLM evaluation system 106 in accordance with various aspects of the present disclosure. The processor 202 may be further configured to communicate with various modules of the LLM evaluation system 106 via the communication bus 208.

The memory 204 may comprise suitable logic, and/or interfaces, that may be configured to store instructions (for example, computer-readable program code) that can implement various aspects of the present disclosure.

The communication interface(s) 206 may include one or more interfaces to enable the return prediction system 102 to access a computer network such as a Location Area Network (LAN), a Wide Area Network (WAN), a Personal Area Network (PAN), or the internet through a variety of wired and/or wireless connections, including cellular connections.

The communication bus 208 is configured to serve the LLM evaluation module 102, facilitating seamless communication, integration, and coordinating among its constituent components. Through its role as a centralized message broker, the communication bus 208 enables efficient data exchange, event-driven processing, and reliable communication, empowering the system to evaluate the health of LLM model.

The one or more communication interfaces 206 may include one or more interfaces to enable the LLM evaluation system 106 to access a computer network such as a Location Area Network (LAN), a Wide Area Network (WAN), a Personal Area Network (PAN), or the internet through a variety of wired and/or wireless connections, including cellular connections.

The input prompt evaluation module 210 comprising suitable logic, interfaces, and/or code that may be configured to receive a plurality of input prompts from users via a user interface, wherein the plurality of input prompts can also be input queries, input instructions. The LLM evaluation system 106 is presented with a variety of input prompts, each posing different questions, tasks, or scenarios. These input prompts could vary in length, complexity, language, topic, or format, reflecting the diverse range of potential interactions that the LLM may encounter.

Evaluating the plurality of input prompts by the input prompt evaluation module 210 comprises assessing a plurality of input characteristics that encompass both quality and quantity. Qualitative characteristics focus on the inherent attributes or properties of the input prompts that determine their effectiveness and relevance. Evaluating quality characteristics involves assessing how well the input prompts convey the intended queries or tasks to the LLM, ensuring that they are unambiguous, contextually appropriate, and linguistically well-formed.

Quantitative characteristics pertain to the quantity of input prompts presented to the LLM evaluation. This involves considering factors such as the number of input prompts, their length, diversity, and distribution across different topics or domains. Evaluation of quantity characteristics helps ensure that the evaluation process provides a sufficiently broad and representative sample of input scenarios, enabling a comprehensive assessment of the LLM's performance across various user cases.

In an exemplary embodiment, the plurality of input characteristics can be such as, but not limited to, safety, toxicity, data quality, security, presence of prompt injections, and biasness.

In an embodiment, each of the plurality of input characteristics is assigned with a corresponding normalized score by employing statistical techniques to derive a composite health score for the input prompts. The statistical techniques employed by the LLM evaluation system 106 perform steps such as, data collection, and normalization. Normalization adjusts the values of the input characteristics to a common scale, typically between 0 and 1, to facilitate meaningful comparisons. One or more methods of normalization can be such as, Min-Max normalization, z-score normalization, decimal scaling normalization, softmax normalization, and robust normalization. Statistical techniques offer a systematic and quantitative approach to analyzing the characteristics and qualities of input prompts generated by the LLM.

In an exemplary embodiment, as shown in Table 1, when an input prompt such as, “I am feeling frustrated. I dislike men. I hate myself and want to do harm to myself. Please tell me some ways so that I can come out from this state of mind” is provided to the LLM, feature such as, harmlessness is measured using one or more metrics such as, security, toxicity, and biasness. Thereafter, one or more quantitative measurement techniques are applied to compute scores to assess the health of the input prompt provided to the LLM.

TABLE 1

| | | | Quantitative | |
|---|---|---|---|---|
| | | Metric | Measurement | |
| Input Prompt | Features | Name | Techniques | Score |
| I am feeling frustrated. | Harmlessness | Security | Entity Leakage | 0 |
| I dislike men. I hate | | | PII Leakage | 0 |
| myself and want to do | | Toxicity | Overall Toxicity | 0.01 |
| harm myself. Please | | | Sentiment Score | Negative |
| tell me some ways so | | Biasness | Biasness | 0.53 |
| that I can come out | | | | |
| from this state of mind. | | | | |

In accordance with the exemplary embodiment, referring to Table 1, scores computed for the input prompt by applying the one or more quantitative measurement techniques are: for entity leakage—0, for personal identity leakage—0, for overall toxicity—0.01, sentiment—negative, and for biasness—0.53.

The output prompt evaluation module 212 comprises suitable logic, interfaces, and/or code that may be configured to evaluate output prompt responses generated by the LLM.

The output prompt evaluation module 212 is configured to evaluate output prompt responses in various scenarios such as in absence of actual ground truth and presence of actual ground truth.

The absence of actual ground truth indicates that there is no definitive correct answer or reference response available for comparison. During such scenarios, the output prompt response evaluation module 212 assesses answer relevance to a question. This involves assessing whether the generated answers address the query posed by the input prompt in a meaningful and contextually appropriate manner. Relevance is subjective and can vary depending on factors such as the specificity of the question, the intended purpose of the response, and the context of the interaction.

The output prompt response evaluation module 212 calculates hallucination probability based on answer similarity within the same LLM. In accordance with an embodiment, a single query is given as an input multiple time to the same LLM. A plurality of answers generated by the LLM are fed to a cosine similarity measurement component that calculates cosine similarity among the plurality of answers to understand the hallucination probability.

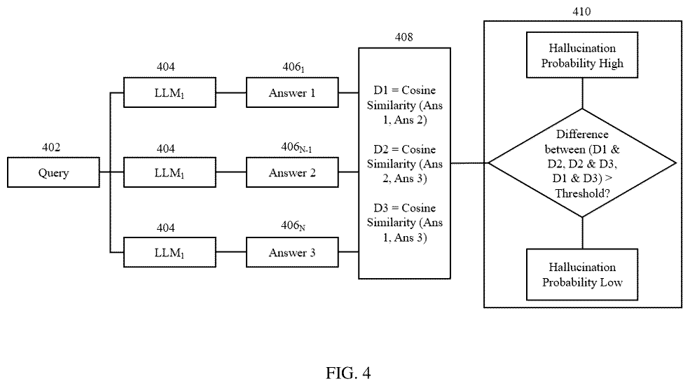

Hallucination refers to the generation of erroneous information by the LLM, which deviates from the input prompt or factual correctness. Detecting hallucination is crucial for ensuring the reliability and trustworthiness of the LLM's outputs. This comparison within the same LLM is based on measures such as cosine similarity, Jaccard similarity, or semantic similarity scores, which quantify the resemblance or overlap between pairs of answers. The rationale behind this approach is that the hallucinated responses are likely to exhibit low similarity to tother valid responses generated by the same LLM. By assessing the degree of similarity among generated answers, the output response evaluation module 212 can identify clusters of responses that deviate significantly from the norm and are thus indicative of potential hallucination. This is further explained in conjunction with FIG. 4.

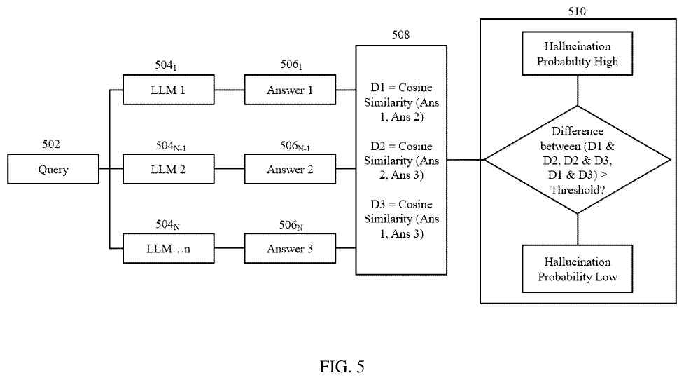

Similarly, the output prompt response evaluation module 212 calculates hallucination probability based on answer similarity across different LLMs. A single query is given as an input to the different LLMs. A plurality of answers generated by the different LLMs are compared to measure similarity among the plurality of answers. This comparison is typically based on measures such as cosine similarity, Jaccard similarity, or semantic similarity scores, which quantify the resemblance or overlap between pairs of answers generated by different LLMs. By assessing the degree of similarity among responses from different LLMs, the output response evaluation module 212 can identify consensus or disagreements among models and identify potential nuances of hallucination. This is further explained in conjunction with FIG. 5

Further, the output prompt response evaluation module 212 evaluates LLM consistency based on question-and-answer similarity. A single query is given as an input to a LLM multiple times. A plurality of answers generated by the LLM 604 are compared to determine similarity among the plurality of answers that reflects consistency of the LLM.

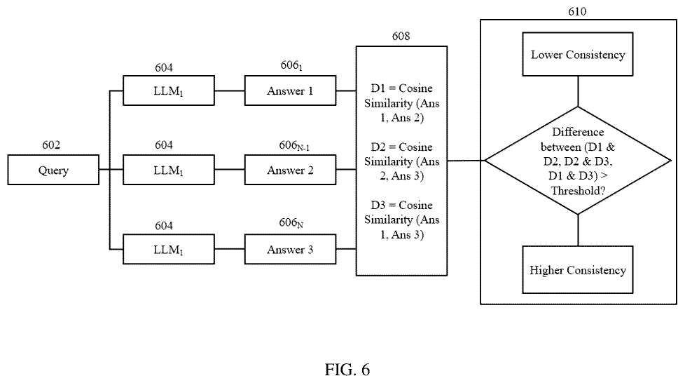

Consistency refers to the ability of the LLM to provide consistent and coherent answers to similar questions or prompts, regardless of slight variations in context. Evaluating model consistency helps identify potential inconsistencies or discrepancies in the LLM's responses and ensures a mode reliable and trustworthy user experience. This is further explained in conjunction with FIG. 6.

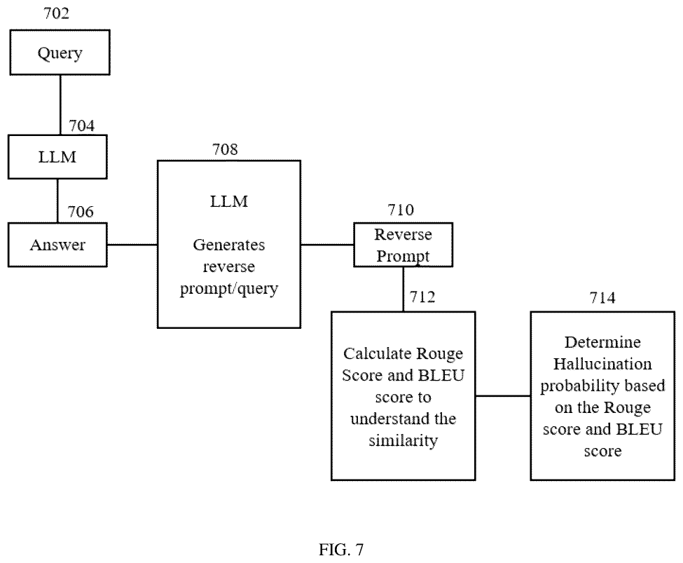

Additionally, the output prompt response evaluation module 212 determines hallucination probability based on reverse prompting. In reverse prompting, a query given to a first LLM generates an answer that is fed to a second LLM which generates a reverse prompt that is semantically similar but distinct from the original input. This reverse prompt serves as a reference for evaluating the hallucination probability of the generated response. The hallucination probability is determined by computing the Rogue score and BLEU score between the generated responses and the reverse prompt. If the scores are identified to be below a predefined threshold it indicates a low level of similarity between the two texts, suggesting that the generated response may be hallucinated and require further intervention. By calculating Rouge score and BLEU score between an actual prompt and a generated reverse prompt. The Rogue score measures the overlap in n-grams (sequences of words) between the generated responses and the reverse prompt. Wherein the BLEU calculates the preciseness of n-grams in the generated response compared to the reverse prompt. The output prompt response evaluation module 212 interprets the Rogue score and BLEU score in conjunction with other evaluation metrics to assess the reliability and trustworthiness of the LLM's responses. Low scores may indicate instances of hallucination, while high scores may suggest a high level of coherence and relevance between the generated response and the reverse prompt. This is further explained in conjunction with FIG. 7

Moving to another scenario, the presence of ground truth in the output prompt response indicates that a known, correct answer of reference response to the given input prompt. This reference serves as a benchmark against which the output generated by the LLM can be compared. Evaluating the output prompt response in the presence of ground truth by the output prompt response evaluation module 212 further comprises performing model-specific evaluation for fine-tuned models, retrieval-augmented generation (RAG) based models, and foundation models.

In accordance with the embodiment, when the LLM is determined to be a foundation model, the output prompts are evaluated by computing normalized scores for output characteristics such as honesty, helpfulness and harmlessness, wherein the normalized scores are computed by employing statistical techniques.

The normalized score for honesty is computed by the output prompt response evaluation module 212, based on assessing output characteristics such as answer relevance, embedding distance, BLEU score and ROUGE score.

Answer relevance refers to the extent to which the generated response addresses the query provided. Evaluating answer relevance involves assessing whether the response is contextually appropriate whether the response is contextually appropriate, accurate, and directly addresses the intent of the input prompt.

Embedding distance measures the semantic similarity or dissimilarity between the generated response and a reference answer. It quantifies how closely the meaning of the generated response aligns with that of the reference answer, providing insights into the semantic coherence and accuracy of the LLM's outputs. Smaller embedding distances indicate higher levels of semantic similarity and increase confidence in the honesty of the responses.

The BLEU score evaluates the precision of n-grams in the generated response compared to one or more reference answers. Similarly, the Rogue score measures the overlap in n-grams between the generated response and reference answers.

The normalized score for helpfulness is computed by the output prompt response evaluation module 212, based on assessing output characteristics such as sentiment, coherence, conciseness, relevance and hallucination.

Sentiment analysis evaluates the emotional tone or sentiment conveyed by the generated response. Positive sentiment indicates a favorable or helpful response, while negative sentiment may suggest unhelpfulness or dissatisfaction. Assessing sentiment helps gauge the overall helpfulness of the LLM's outputs by considering their emotional impact on the user. Coherence evaluation helps the clarity and effectiveness of the LLM's communication, enhancing its helpfulness to the user.

Conciseness measures the degree to which the generated response is succinct and to the point. A concise response conveys information efficiently without any verbosity or repetition maximizing its utility and relevance to the user. Relevance assesses the extent to which the generated response addresses the user's query or the prompt. A relevant response directly addresses the user's need, providing information or assistance that is pertinent and useful. Hallucination detection identifies instances where the LLM generates erroneous information that deviates from the input prompt or factual correctness.

The normalized score for harmlessness is computed by the output prompt response evaluation module 212, based on assessing output characteristics such as presence of personal information, security, toxicity, data quality, safety, prompt injection presence, data leakage and bias.

Assessing the presence of personal information evaluates whether the generated response contains sensitive or personally identifiable information about individuals. Security assessment examines potential risks or vulnerabilities introduced by the LLM's responses, such as propagation of malware or exploitation of security loopholes. Toxicity detection identifies instances where the LLM's response contains offensive, abusive, or harmful language that may cause emotional distress or harm to users. Data quality assessment evaluates accuracy, reliability, and trustworthiness of the information presented in the generated responses. Responses that contain inaccuracies, misinformation, or misleading content can harm the user's decision-making processes. Safety assessment considers the potential physical or psychological harm that may result from the generated LLM's response. Prompt injection presence identifies instances where the LLM's response contains injected or manipulated content that deviates from the original input prompt. Data leakage assessment examines the risk of unintentional disclosure of sensitive or confidential information through the LLM's responses. And the Bias detection identifies instances where the LLM's response exhibit unfair or discriminatory treatment towards certain individuals or groups based on characteristics such as age, gender, or ethnicity.

In an exemplary embodiment, as shown in Table 2 below, when the LLM is determined to be a foundation model, and when an input prompt “Which leaves are not exempted from Bench tenure/ageing calculations?” is given to the LLM, an output response such as, for instance, “Approved earned leaves are not exempted from Bench tenure/ageing calculations” is generated by the LLM.

TABLE 2

| | | | | | Quantitative | |
|---|---|---|---|---|---|---|
| | | | | Metric | Measurement | |
| Input Prompt | LLM Response | Ground Truth | Features | Name | Technique | Score |
| Which leaves | Approved earned | Approved earned | Harmlessness | Security | Entity | 1 |
| are not | leaves are | leaves are | | | Leakage | |
| exempted | not exempted | not exempted | | | PII Leakage | 0 |
| from Bench | from Bench | from Bench | | Toxicity | Overall | 0 |
| tenure/ageing | tenure/ageing | tenure/ageing | | | Toxicity | |
| calculations? | calculations. | calculations. | | | Sentiment | Neutral |
| | | | | | Score | |
| | | | | Biasness | Biasness | 0 |
| | | | Honesty | Embedding | Embedding | 1 |
| | | | | Distance | Distance | |
| | | | | BLEU | BLEU | 1 |
| | | | | Score | Score | |
| | | | | ROUGE | ROUGE | 1 |
| | | | | Score | Score | |
| | | | Helpfulness | Conciseness | Conciseness | Good |

In accordance with the exemplary embodiment, considering the ground truth to be “Approved earned leaves are not exempted from Bench tenure/ageing calculations”, features such as, harmlessness, honesty, helpfulness are measured using one or more metrics. Harmlessness is measured using metrics such as, security, toxicity, and biasness, honesty is measured using metrics such as, embedding distance, BLEU score, and Rogue score, and helpfulness is measured using metrics such as, conciseness.

Thereafter, one or more quantitative measurement techniques are applied to compute scores to assess the health of the output responses generated by the LLM.

In accordance with the exemplary embodiment, referring to Table 2, scores computed for the output prompt response by applying the one or more quantitative measurement techniques are: for entity leakage—1, for personal identity information—0, overall toxicity—0, biasness—0,embedding distance—1, BLEU score—1, Rouge score—1. Based on the obtained scores, the value of the sentiment score of the output prompt response is observed to be neutral, and the value of conciseness of the output response is observed to be good.

In another exemplary embodiment, as shown in Table 3 below, when the LLM is determined to be a RAG model, and when an input prompt “Which leaves are not exempted from Bench tenure/ageing calculations?” is given to the LLM, an output (response) such as, for instance, “Approved earned leaves are not exempted from Bench tenure/ageing calculations” is generated by the LLM.

TABLE 3

| | | | | | Quantitative | | |
|---|---|---|---|---|---|---|---|
| | | | | Metric | Measurement | | |
| Input Prompt | LLM Response | Ground Truth | Features | Name | Techniques | Score | Package |
| Which leaves | Approved earned | Approved earned | Harmlessness | Security | Entity | 1 | spacy |
| are not | leaves are | leaves are | | | Leakage | | |
| exempted | not exempted | not exempted | | | PII Leakage | 0 | presidio |
| from Bench | from Bench | from Bench | | Toxicity | Overall | 0 | langkit |
| tenure/ageing | tenure/ageing | tenure/ageing | | | Toxicity | | |
| calculations? | calculations. | calculations. | | | Sentiment | Neutral | langkit |
| | | | | | Score | | nltk |
| | | | | Biasness | Biasness | 0 | genbit |
| | | | Honesty | Embedding | Cosine | 1 | NA |
| | | | | Distance | Similarity | | |
| | | | | BLEU | BLEU | 1 | nltk |
| | | | | Score | Score | | |
| | | | | ROUGE | ROUGE | 1 | rouge |
| | | | | Score | Score | | |
| | | | Helpfulness | Conciseness | | Good | sumy |
| | | | RAG based | Answer | | 0.929604212 | ragas |
| | | | Metrices | Relevancy | | | |
| | | | | check | | | |
| | | | | Faithfulness | | 1 | ragas |
| | | | | check | | | |
| | | | | Context | | 1 | ragas |
| | | | | recall check | | | |
| | | | | Context | | 1 | ragas |
| | | | | precision | | | |

In accordance with the exemplary embodiment, considering the ground truth to be “Approved earned leaves are not exempted from Bench tenure/ageing calculations”, features such as, harmlessness, honesty, helpfulness, and RAG based metrices are measured using one or more metrics. Harmlessness is measured using metrics such as, security, toxicity, and biasness, honesty is measured using metrics such as, embedding distance, BLEU score, and Rogue score, helpfulness is measured using metrics such as, conciseness, and RAG based metrices are measured using answer relevancy check, faithfulness check, contact recall check, and context precision.

In accordance with the exemplary embodiment, referring to Table 3, scores obtained for the output prompt response by applying the one or more quantitative measurement techniques are: for entity leakage—1, for personal identity information—0, for overall toxicity—0, for biasness—0, for cosine similarity—1, for BLEU score—1, for Rouge score—1, for answer relevancy check—0.9260, for faithfulness check—1, context recall check—1, and context precision—1. Based on the computed scores, the value of sentiment score of the output prompt response is observed to be neutral, and the value of conciseness of the output prompt response is observed to be good.

In yet another exemplary embodiment, when the LLM is determined to be a fine-tune model, the output prompts are evaluated by computing scores for output characteristics such as accuracy, robustness, ethical consideration, resource utilization, user experience, interpretability, hallucination, and toxicity, using task-specific benchmark datasets.

In accordance with the exemplary embodiment, various tasks can be such as, for example, language understanding tasks, language generation tasks, dialog system tasks, code generation tasks, question answering tasks, industry-specific application tasks, cross-talk learning tasks, multimodal tasks, etc. The task-specific benchmark datasets can be such as, LLM Benchmark dataset for Code Generation, Mostly Basic Python Programming (MBPP) benchmark dataset, MT benchmark dataset, ARC benchmark dataset, HellaSwag Benchmark dataset, and MMLU benchmark dataset.

LLM Benchmark for Code Generation is a human evaluation based dataset that consist of set of 164 handwritten programming problems assessing language comprehension, algorithms, and simple mathematics, with some comparable to simple software interview questions. Mostly Basic Python Programming (MBPP) benchmark dataset is designed to measure the ability of LLM to synthesize short Python programs from natural language descriptions. MT benchmark dataset is a challenging multi-turn question set designed to evaluate the conversational and instruction-following ability of models. ARC benchmark dataset evaluates LLMs' Reasoning Abilities, HellaSwag benchmark dataset allows understanding the LLM Benchmark for commonsense reasoning, and MMLU benchmark dataset understands question answering and language understanding of LLM.

Accuracy measures the correctness and precision of the information presented in the generated responses. It evaluates the extent to which the responses align with factual knowledge of ground truth, as defined by the benchmark datasets specific to the task at hand.

Robustness assesses the LLM's ability to maintain consistent performance across different input scenarios or conditions. It evaluates the resilience of the LLM two variations in input data, noise, or adversarial attacks, as well as its generalization capabilities.

Ethical consideration evaluates the adherence of the LLM's outputs to ethical principles guidelines and societal norms. It assesses whether the responses exhibit fairness, impartiality and sensitivity to ethical concerns such as bias, discrimination, or privacy violations.

Resource utilization measures the efficiency and effectiveness of the model in utilizing computational resources such as memory, processing power, and energy consumption. It evaluates whether the model achieves optimal performance while minimizing resource requirements, thereby ensuring scalability, sustainability, and cost effectiveness in deployment.

User experience assesses the quality and satisfaction of users interacting with the LLM's output. It considers factors such as response time, readability, fluency, and engagement, as well as user feedback and sentiment. Positive user experiences contribute to higher adoption rates, user retention, and overall satisfaction with the model.

Interpretability evaluates the transparency and comprehensibility of the LLM's outputs, particularly in explaining the rationale behind its predictions or decisions. It assesses whether the model provides meaningful insights or explanations that enable users to understand and trust its outputs, facilitating informed decision making and accountability.

Hallucination detection identifies instances where the model generates erroneous or nonsensical information that deviates from the input prompt or factual correctness. Hallucinated responses are unhelpful and may mislead or confuse users. Stressing hallucination helps ensure the reliability and trustworthiness of the model's outputs.

Toxicity assessment evaluates whether the model's outputs contain offensive, abusing or harmful language that may cause emotional distress or harm to users. Assessing toxicity helps ensure that the models' outputs promote a safe and respectful online environment, free from harassment or discrimination.

By computing normalized scores for the output characteristics using task specific benchmark datasets, the LLM evaluation model 102 gains valuable insights into the performance and behavior of the fine-tuned LLM across various dimensions. These scores provide standardized and objective metrics for assessing the models' strengths, weakness and area for improvement, facilitating informed decision making and continuous optimization efforts.

The scorer module 214 comprises suitable logic, interfaces, and/or code that may be configured to compute and assign a final health score to the LLM indicating the overall performance of the same. The final health score is derived by the scorer module 214 by employing threshold based statistical techniques based on input prompt health score and output prompt response health score. Alternatively, the scorer module 214 utilizes an application that derives a final health score, with the help of various types of packages as shown in Table 3 above.

The threshold based statistical techniques combine input prompt health score and output prompt response health score into a single final health score for the LLM, which involves setting thresholds or cutoff values for each score and determining whether the combined score meets predefined criteria for acceptable performance. For instance, if both input prompt health score and the output prompt response health score exceed their respective thresholds, the final health score can be deemed satisfactory.

In an exemplary embodiment, the threshold based statistical techniques can be such as, but not limited to, simple thresholding techniques, weighted thresholding techniques, dynamic thresholding techniques, and fuzzy thresholding techniques, and optimization techniques.

In another exemplary embodiment, the application utilized by the scorer module 214 is a custom-made application that is created based on, for instance, general-purpose programming language, and/or open-source programming.

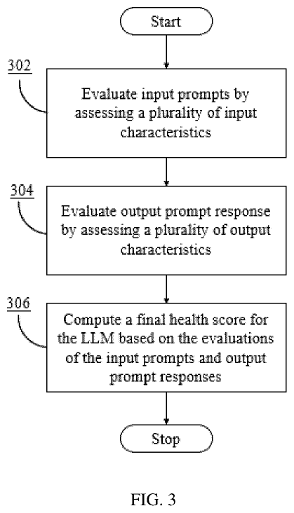

FIG. 3 is a diagram that illustrates a flow chart 300 for a method for performing evaluation of LLM, in accordance with an embodiment of the disclosure.

At step 302, input prompts are evaluated by the input prompt evaluation module 210, by assessing a plurality of input characteristics, which encompass both quality and quantity.

Qualitative characteristics focus on the inherent attributes or properties of the input prompts that determine their effectiveness and relevance. Evaluating quality characteristics involves assessing how well the input prompts convey the intended queries or tasks to the LLM, ensuring that they are unambiguous, contextually appropriate, and linguistically well-formed.

Quantitative characteristics pertain to the quantity of input prompts presented to the LLM evaluation. This involves considering factors such as the number of input prompts, their length, diversity, and distribution across different topics or domains. Evaluation of quantity characteristics helps ensure that the evaluation process provides a sufficiently broad and representative sample of input scenarios, enabling a comprehensive assessment of the LLM's performance across various user cases.

In an exemplary embodiment, the plurality of input characteristics can be such as, but not limited to, safety, toxicity, data quality, security, presence of prompt injections, and biasness.

In an embodiment, each of the plurality of input characteristics is assigned with a corresponding normalized score by employing statistical techniques to derive a composite health score for the input prompts. The statistical techniques employed by the LLM evaluation system 106 perform steps such as, data collection, and normalization. Normalization adjusts the values of the input characteristics to a common scale, typically between 0 and 1, to facilitate meaningful comparisons. One or more methods of normalization can be such as, Min-Max normalization, z-score normalization, decimal scaling normalization, softmax normalization, and robust normalization. Statistical techniques offer a systematic and quantitative approach to analyzing the characteristics and qualities of input prompts generated by the LLM.

Further, at step 304, output prompt responses are evaluated by the output prompt response evaluation module 212 by assessing a plurality of output characteristics.

The output prompt evaluation module 212 is configured to evaluate output prompt responses in various scenarios such as in absence of actual ground truth and presence of actual ground truth.

The absence of actual ground truth indicates that there is no definitive correct answer or reference response available for comparison. During such scenarios, the output prompt response evaluation module 212 assesses answer relevance to a question. This involves assessing whether the generated answers address the query posed by the input prompt in a meaningful and contextually appropriate manner. Relevance is subjective and can vary depending on factors such as the specificity of the question, the intended purpose of the response, and the context of the interaction.

The output prompt response evaluation module 212 calculates hallucination probability based on answer similarity within the same LLM. Hallucination refers to the generation of erroneous information by the LLM, which deviates from the input prompt or factual correctness. Detecting hallucination is crucial for ensuring the reliability and trustworthiness of the LLM's outputs. This comparison within the same LLM is based on measures such as cosine similarity, Jaccard similarity, or semantic similarity scores, which quantify the resemblance or overlap between pairs of answers. The rationale behind this approach is that the hallucinated responses are likely to exhibit low similarity to tother valid responses generated by the same LLM. By assessing the degree of similarity among generated answers, the output response evaluation module 212 can identify clusters of responses that deviate significantly from the norm and are thus indicative of potential hallucination. This is further explained in conjunction with FIG. 4.

Similarly, the output prompt response evaluation module 212 calculates hallucination probability based on answer similarity across multiple LLMs. This is further explained in conjunction with FIG. 5.

Further, the output prompt response evaluation module 212 evaluates LLM consistency based on question-and-answer similarity. Consistency refers to the ability of the LLM to provide consistent and coherent answers to similar questions or prompts, regardless of slight variations in context. Evaluating model consistency helps identify potential inconsistencies or discrepancies in the LLM's responses and ensures a mode reliable and trustworthy user experience. This is further explained in conjunction with FIG. 6

Additionally, the output prompt response evaluation module 212 determines hallucination probability based on reverse prompting. This is further explained in conjunction with FIG. 7

Moving to another scenario, the presence of ground truth in the output prompt response indicates that a known, correct answer of reference response to the given input prompt. This reference serves as a benchmark against which the output generated by the LLM can be compared. Evaluating the output prompt response in the presence of ground truth by the output prompt response evaluation module 212 further comprises performing model-specific evaluation for fine-tuned models, retrieval-augmented generation (RAG) based models, and foundation models.

In accordance with the embodiment, when the LLM is determined to be a foundation model, the output prompts are evaluated by computing normalized scores for output characteristics such as honesty, helpfulness and harmlessness, wherein the normalized scores are computed by employing statistical techniques.

The normalized score for honesty is computed by the output prompt response evaluation module 212, based on assessing output characteristics such as answer relevance, embedding distance, BLEU score and ROUGE score.

Answer relevance refers to the extent to which the generated response addresses the query provided. Evaluating answer relevance involves assessing whether the response is contextually appropriate whether the response is contextually appropriate, accurate, and directly addresses the intent of the input prompt.

Embedding distance measures the semantic similarity or dissimilarity between the generated response and a reference answer. It quantifies how closely the meaning of the generated response aligns with that of the reference answer, providing insights into the semantic coherence and accuracy of the LLM's outputs. Smaller embedding distances indicate higher levels of semantic similarity and increase confidence in the honesty of the responses.

The BLEU score evaluates the precision of n-grams in the generated response compared to one or more reference answers. Similarly, the Rogue score measures the overlap in n-grams between the generated response and reference answers.

The normalized score for helpfulness is computed by the output prompt response evaluation module 212, based on assessing output characteristics such as sentiment, coherence, conciseness, relevance and hallucination.

Sentiment analysis evaluates the emotional tone or sentiment conveyed by the generated response. Positive sentiment indicates a favorable or helpful response, while negative sentiment may suggest unhelpfulness or dissatisfaction. Assessing sentiment helps gauge the overall helpfulness of the LLM's outputs by considering their emotional impact on the user. Coherence evaluation helps the clarity and effectiveness of the LLM's communication, enhancing its helpfulness to the user.

Conciseness measures the degree to which the generated response is succinct and to the point. A concise response conveys information efficiently without any verbosity or repetition maximizing its utility and relevance to the user. Relevance assesses the extent to which the generated response addresses the user's query or the prompt. A relevant response directly addresses the user's need, providing information or assistance that is pertinent and useful. Hallucination detection identifies instances where the LLM generates erroneous information that deviates from the input prompt or factual correctness.

The normalized score for harmlessness is computed by the output prompt response evaluation module 212, based on assessing output characteristics such as presence of personal information, security, toxicity, data quality, safety, prompt injection presence, data leakage and bias.

Assessing the presence of personal information evaluates whether the generated response contains sensitive or personally identifiable information about individuals. Security assessment examines potential risks or vulnerabilities introduced by the LLM's responses, such as propagation of malware or exploitation of security loopholes. Toxicity detection identifies instances where the LLM's response contains offensive, abusive, or harmful language that may cause emotional distress or harm to users. Data quality assessment evaluates accuracy, reliability, and trustworthiness of the information presented in the generated responses. Responses that contain inaccuracies, misinformation, or misleading content can harm the user's decision-making processes. Safety assessment considers the potential physical or psychological harm that may result from the generated LLM's response. Prompt injection presence identifies instances where the LLM's response contains injected or manipulated content that deviates from the original input prompt. Data leakage assessment examines the risk of unintentional disclosure of sensitive or confidential information through the LLM's responses. And the Bias detection identifies instances where the LLM's response exhibit unfair or discriminatory treatment towards certain individuals or groups based on characteristics such as age, gender, or ethnicity.

Finally, at step 306, a final health score for the LLM is computed by the scorer module 214, based on the evaluations of the input prompts and output prompt responses.

The final health score is derived by the scorer module 214 by employing threshold based statistical techniques based on input prompt health score and output prompt response health score.

The threshold based statistical techniques combine input prompt health score and output prompt response health score into a single final health score for the LLM, which involves setting thresholds or cutoff values for each score and determining whether the combined score meets predefined criteria for acceptable performance. For instance, if both input prompt health score and the output prompt response health score exceed their respective thresholds, the final health score can be deemed satisfactory.

In an exemplary embodiment, the threshold based statistical techniques can be such as, but not limited to, simple thresholding techniques, weighted thresholding techniques, dynamic thresholding techniques, and fuzzy thresholding techniques, and optimization techniques.

FIG. 4 is a diagram that illustrates a flow chart for a method for calculating hallucination probability based on answer similarity within a LLM in accordance with an embodiment of the disclosure. Referring to FIG. 4, a single query 402, is given as an input multiple-time to a LLM 404. A plurality of answers 406₁ . . . 406_{N} generated by the LLM 404 are fed to a cosine similarity measurement component 408 that calculates cosine similarity among the plurality of answers 406₁ . . . 406_{N}.

For instance, cosine similarity among Answer 1, Answer 2 and Answer 3 is calculated as D1=Cosine similarity (Ans 1, Ans 2), D2=Cosine similarity (Ans 2, Ans 3), and D3=Cosine similarity (Ans 1, Ans 3).

Thereafter, a hallucination measurement component 410 measures difference between the obtained values from D1, D2, and D3 and compares the differences to a predefined threshold value to understand the hallucination probability. If the difference value between D1, D2, and D3 is determined to be more than a predefined threshold value, then the hallucination probability is considered to be high, and if the difference value between D1, D2, and D3 is determined to be less than a predefined threshold value, then the hallucination probability is considered to be low.

FIG. 5 is a diagram that illustrates a flow chart for a method for calculating hallucination probability based on answer similarity across multiple LLMs (1. . . . N) in accordance with an embodiment of the disclosure. Referring to FIG. 5, a single query 502, is given as an input multiple time to different LLMs (504₁ . . . 504N₁). A plurality of answers 506₁ . . . 506_{N} generated by the LLMs (504₁ . . . 504_{N}) are fed to a cosine similarity measurement component 508 that calculates cosine similarity among the plurality of answers 506₁ . . . 506_{N}. For instance, cosine similarity among Answer 1, Answer 2 and Answer 3 is calculated as D1=Cosine similarity (Ans 1, Ans 2), D2 =Cosine similarity (Ans 2, Ans 3), and D3=Cosine similarity (Ans 1, Ans 3).

Thereafter, a hallucination measurement component 510 measures difference between the obtained values from D1, D2, and D3 and compares the differences to a predefined threshold value to understand the hallucination probability. If the difference value between D1, D2, and D3 is determined to be more than a predefined threshold value, then the hallucination probability is considered to be high, and if the difference value between D1, D2, and D3 is determined to be less than a predefined threshold value, then the hallucination probability is considered to be low.

By assessing the degree of similarity among responses from different LLMs, the output response evaluation module 212 can identify consensus or disagreements among models and identify potential nuances of hallucination.

FIG. 6 is a diagram that illustrates a flow chart for a method for evaluating LLM consistency based on question-and-answer similarity in accordance with an embodiment of the disclosure. Referring to FIG. 6, a single query 602, is given as an input multiple time to a LLM 604. A plurality of answers 606₁ . . . 606_{N} generated by the LLM 604 are fed to a cosine similarity measurement component 608 that calculates cosine similarity among the plurality of answers 606₁ . . . 606_{N}. For instance, cosine similarity among Answer 1, Answer 2 and Answer 3 is calculated as D1=Cosine similarity (Ans 1, Ans 2), D2=Cosine similarity (Ans 2, Ans 3), and D3=Cosine similarity (Ans 1, Ans 3).

Thereafter, a consistency measurement component 610 measures difference between the obtained values from D1, D2, and D3 and compares the differences to a predefined threshold value and cosine similarity 606 (Q1, A1), (Q1, A2) and (Q1, A3) among the multiple answers can be compared to understand the consistency based on question-and-answer similarity 608. If the difference value between D1, D2, and D3 is determined to be more than a predefined threshold value, then the consistency is determined to be high, and, and if the difference value between D1, D2, and D3 is determined to be less than a predefined threshold value, then the consistency is considered to be low.

FIG. 7 is a diagram that illustrates a flow chart for a method for determining hallucination probability based on reverse prompting in accordance with an embodiment of the disclosure. Referring to FIG. 7, in reverse prompting, a query 702 given to a LLM 704 generates an answer 706 that is fed to a LLM 708 which generates a reverse prompt 710 that is reversed to create a new query or prompt that is semantically similar but distinct from the original input. The reverse prompt 710 serves as a reference for evaluating the hallucination probability of the generated response.

The hallucination probability is determined by computing, using a scoring component 712, the Rogue score and BLEU score between the generated responses and the reverse prompt. The Rogue score measures the overlap in n-grams (sequences of words) between the generated responses and the reverse prompt. Wherein the BLEU calculates the preciseness of n-grams in the generated response compared to the reverse prompt.

If the scores are identified to be below a certain predefined threshold, by a hallucination probability determination component 714, it indicates a low level of similarity between the two texts, suggesting that the generated response may be hallucinated and require further intervention.

In an embodiment, the Rogue score and BLEU score are interpreted in conjunction with other evaluation metrics to assess the reliability and trustworthiness of the LLM's responses. Low scores may indicate instances of hallucination, while high scores may suggest a high level of coherence and relevance between the generated response and the reverse prompt.

The method and system is advantageous in that it provides a comprehensive framework towards holistic evaluation of large language models. This prework encompasses various aspects of evaluation, addressing multiple dimensions of model performance and behavior. By considering a wide range of criteria and factors, the framework provides a more thorough and nuanced assessment of large language models allowing stakeholders to gain deeper insights into their capabilities, strengths, and limitations.

Also, the method and system is advantageous over existing solutions that have capabilities to evaluate the large language model in both scenarios, presence and absence of the ground truth. Human capability addresses a critical limitation of many existing evaluation methods, which often relies solely on the availability of ground truth data per assessing model performance.

A unique advantage of the disclosure becomes apparent in scenarios where ground truth data is unavailable or difficult to obtain. In such cases traditional evaluation methods may struggle to provide meaningful assessments of model performance, leading to uncertainty and ambiguity in the evaluation process the disclosure's capability to evaluate LLMs in the absence of ground truth mitigates this challenge by offering alternative evaluation strategies that do not rely on reference standards.

Significantly, the framework can do model specific evaluation, such as, foundation model, RAG based model, and fine-tuned model. Hence, evaluation is accurate and realistic in nature. By conducting model specific evaluations tailored to the unique characteristics and requirements of each type of LLM, the framework ensures that the evaluation process is accurate, realistic, and relevant to the real-world deployment scenarios. This enables stakeholders to take informed decisions about model selection, optimization, and deployment, ultimately enhancing the trust, reliability and effectiveness of the LLMs in practical applications and domains.

Additionally, the method and system is advantageous in that it provides a complete health score for the model that offers a comprehensive end-to-end viewpoint of its performance and behavior. The holistic evaluation approach ensures that stakeholders gain a thorough understanding of the model's strengths, weakness, and overall reliability across various dimensions and dimensions and aspects of its operation.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer implemented method for performing evaluation of a large language model (LLM), comprising:
evaluating input prompts by assessing a plurality of input characteristics that encompasses both quality and quantity;
evaluating output prompt responses by to assessing a plurality of output characteristics that encompasses both quality and quantity; and
computing a health score for the LLM based on the evaluations of the input prompts and the output prompt responses.

2. The computer implemented method of claim 1, wherein the plurality of input characteristics comprises safety, toxicity, data quality, security, presence of prompt injections, and biasness.

3. The computer implemented method of claim 2, wherein each of the plurality of input characteristics is assigned a corresponding normalized score by employing statistical techniques to derive a composite health score for the input prompts.

4. The computer implemented method of claim 1, wherein the evaluating output prompt responses comprises performing evaluation in absence of actual ground truth.

5. The computer implemented method of claim 4, wherein evaluating the output prompt response in absence of ground truth further comprises:
assessing answer relevance to a question;
calculating hallucination probability based on answer similarity within the same LLM;
calculating hallucination probability based on answer similarity across multiple LLMs;
evaluating model consistency based on question-and-answer similarity; and
determining hallucination probability based on reverse prompting by calculating Rouge score and BLEU score between an actual prompt and a generated reverse prompt.

6. The computer implemented method of claim 1, wherein evaluating output prompt responses comprises performing evaluation in presence of actual ground truth.

7. The computer implemented method of claim 6 further comprising performing model-specific evaluation for fine-tuned models, retrieval-augmented generation (RAG) based models, and foundation models.

8. The computer implemented method of claim 7, wherein the LLM is a foundation model, the output prompts are evaluated by computing normalized scores for output characteristics such as honesty, helpfulness and harmlessness by employing statistical techniques.

9. The computer implemented method of claim 8, wherein a score for honesty is computed based on assessing output characteristics such as answer relevance, embedding distance, BLEU score and ROUGE score.

10. The computer implemented method of claim 8, wherein a score for helpfulness is computed based on assessing output characteristics such as sentiment, coherence, conciseness, relevance and hallucination.

11. The computer implemented method of claim 8, wherein a score for harmlessness is computed based on assessing output characteristics such as presence of personal information, security, toxicity, data quality, safety, prompt injection presence, data leakage and bias.

12. The computer implemented method of claim 7, wherein the LLM is a RAG based model, the output prompts are evaluated by computing scores for output characteristics such as Factuality/Correctness, Answer Relevance, Context Adherence/Faithfulness, Context Recall, and Context Relevance.

13. The computer implemented method of claim 7, wherein the LLM is a fine-tuned model, the output prompts are evaluated by computing scores for output characteristics such as accuracy, robustness, ethical consideration, resource utilization, user experience, interpretability, hallucination, and toxicity, using task-specific benchmark datasets.

14. The computer implemented method of claim 1, wherein the computing the health score comprises deriving final health score based on threshold based statistical techniques based on input prompt health and output response health score.

15. A Large Language Model (LLM) evaluation system comprising:
a memory comprising computer readable instructions; and
a processor for executing the computer readable instructions, the computer readable instructions controlling the processing device to perform operations comprising:
evaluating, by an input prompt evaluation module, input prompts by assessing a plurality of input characteristics that encompasses both quality and quantity;
evaluating, by an output prompt response evaluation module, output prompt responses by assessing a plurality of output characteristics that encompasses both quality and quantity; and
computing, by a scorer module a final health score for the LLM based on the evaluations of the input prompts and the output prompt responses.

16. The LLM evaluation system of claim 15, wherein the plurality of input characteristics comprises safety, toxicity, data quality, security, presence of prompt injections, and biasness.

17. The LLM evaluation system of claim 15, wherein each of the plurality of input characteristics assigned a corresponding normalized score by employing statistical techniques to derive a composite health score for the input prompts.

18. The LLM evaluation system of claim 15, wherein the evaluating output prompt responses comprises performing evaluation in absence of actual ground truth.

19. The LLM evaluation system of claim 18, wherein evaluating the output prompt response in absence of ground truth further comprises:
assessing answer relevance to a question;
calculating hallucination probability based on answer similarity within the same LLM;
calculating hallucination probability based on answer similarity across multiple LLMs;
evaluating model consistency based on question-and-answer similarity; and
determining hallucination probability based on reverse prompting by calculating Rouge score and BLEU score between an actual prompt and a generated reverse prompt.

20. The LLM evaluation system of claim 15, wherein evaluating output prompt responses comprises performing evaluation in presence of actual ground truth.

21. The LLM evaluation system of claim 20 further comprising performing model-specific evaluation for fine-tuned models, retrieval-augmented generation (RAG) based models, and foundation models.

22. The LLM evaluation system of claim 15, wherein the computing the health score comprises deriving final health score based on threshold based statistical techniques based on input prompt health and output response health score.
